(19) United States
(12) Patent Application Publication
(10) Pub. No.: US 2011/0279623 A1
(43) Pub. Date: Nov. 17, 2011

(54) OPTICAL SCANNING DEVICE AND IMAGE FORMING APPARATUS

(76) Inventor: Yasuhiro Ono, Osaka (JP)

(21) Appl. No.: 13/092,503

(22) Filed: Apr. 22, 2011

(30) Foreign Application Priority Data
May 14, 2010 (JP) 2010-112105

(51) Int. Cl. B41J 2/385; G02B 26/08

(52) U.S. Cl. 347/118; 359/205.1

(57) ABSTRACT

An optical scanning device includes a third fθ lens, an adjusting bar, a pressing portion, a columnar member, and a movement restraining section. The adjusting bar is disposed parallel with a longitudinal direction of the third fθ lens and has projections which are capable of pressing against the third fθ lens at plural points in the longitudinal direction of the third fθ lens. The pressing portion and the columnar member press the adjusting bar against the third fθ lens. The movement restraining section is configured to set the pressing portion and the columnar member in a first state in which the pressing portion and the columnar member are movable in a direction parallel with the longitudinal direction of the third fθ lens or in a second state in which the pressing portion and the columnar member are restrained from moving.

### CROSS REFERENCE

This Nonprovisional application claims priority under 35 U.S.C. §119(a) on Patent Application No. 2010-112105 filed in Japan on May 14, 2010 the entire contents of which are hereby incorporated by reference.

### BACKGROUND OF THE INVENTION

The present invention relates to an optical scanning device capable of reducing curvature of a scanning line, as well as an image forming apparatus incorporating such an optical scanning device.

In an electrophotographic image forming apparatus, an optical scanning device is used to apply a scanning line onto a photoreceptor in order to form an electrostatic latent image thereon. Such an optical scanning device includes a plurality of optical elements (i.e., fθ lenses). A scanning line passes through these fθ lenses to reach the photoreceptor.

Therefore, such an fθ lens is required to have the function of transmitting a scanning line therethrough with high precision in order for the scanning line to be applied to a predetermined point on the photoreceptor.

However, the fθ lens has a problem that a scanning line passing therethrough curves because the internal structure of the fθ lens has changed during a cooling process carried out after the molding of the fθ lens.

In attempt to solve this problem, a technique has been disclosed such that the fθ lens is provided at a longitudinally central portion thereof with an adjusting screw which acts to deform the fθ lens by adjusting the amount of pressing by the screw against the fθ lens, thereby reducing the curvature of a scanning line.

With the provision of the adjusting screw only at the longitudinally central portion of the fθ lens, however, the effect of reducing the curvature of a scanning line is low because even though the fθ lens is deformed by the adjusting screw pressing against the fθ lens, only the central portion of the fθ lens is deflected.

In order to overcome this disadvantage, another technique has been disclosed such that the fθ lens is provided with three adjusting screws in total along the longitudinal direction thereof including a screw located adjacent the central portion and the fθ lens is deformed by adjusting the amounts of pressing by the respective screws against the fθ lens, thereby reducing the curvature of the scanning line (see Japanese Patent Laid-Open Publication No. 2007-065500 for example).

With the technique disclosed in Japanese Patent Laid-Open Publication No. 2007-065500, the fθ lens is deflected at three portions thereof and, hence, the effect of reducing the curvature of a scanning line is higher than that exercised by the technique in which the fθ lens is provided with the adjusting screw only at the longitudinally central portion thereof.

It is, however, difficult for the technique described in the Patent Application noted above to deform the fθ lens to such an extent as to minimize the curvature of a scanning line because the screws provided at the three points need to be adjusted individually.

In view of the foregoing problems, a feature of the present invention is to provide an optical scanning device which is capable of easily adjusting the amount of deformation of an optical element.

### SUMMARY OF THE INVENTION

An optical scanning device according to the present invention includes an optical element, a first adjusting section, a first pressing section, and a first movement restraining section. The optical element is disposed in an optical path extending from a light source to a photoreceptor and is configured to correct a scanning line emitted from the light source. The first adjusting section is disposed parallel with a longitudinal direction of the optical element and has projections which are capable of pressing against the optical element at plural points in the longitudinal direction of the optical element. The first pressing section is configured to press the first adjusting section against the optical element. The first movement restraining section is configured to set the first pressing section in a first state in which the first pressing section is movable in a direction parallel with the longitudinal direction of the optical element or in a second state in which the first pressing section is restrained from moving.

Since this arrangement is capable of deforming the optical element by using the single first pressing section to press w against the first adjusting section which is capable of pressing against the optical element at the plural points, the amount of deformation of the optical element can be adjusted easily. Specifically, by moving the first pressing section parallel with the longitudinal direction of the optical element, the point of effort of the first pressing section on the first adjusting section can be shifted, which makes it possible to adjust the pressing force of each projection against the optical element easily.

Since this arrangement is capable of pressing against the optical element at the plural points, the optical element can be deflected at plural portions thereof. Therefore, the arrangement according to the present invention is capable of easily adjusting the amount of deformation of the optical element while effectively reducing the curvature of a scanning line.

### BRIEF DESCRIPTION OF THE DRAWINGS

FIG. 1 is a view illustrating the structure of an image forming apparatus incorporating an optical scanning device according to a first embodiment of the present invention;

FIG. 2 is a plan view illustrating the structure of the optical scanning device according to the first embodiment of the present invention;

FIG. 3 is a side elevational view illustrating the structure of the optical scanning device according to the first embodiment of the present invention;

FIG. 4 is a perspective view illustrating the structure of the optical scanning device according to the first embodiment of the present invention;

FIG. 5A is a plan view illustrating a relevant portion of the structure of the optical scanning device according to the first embodiment of the present invention;

FIG. 5B is a right side view illustrating the relevant portion of the structure of the optical scanning device according to the first embodiment of the present invention;

FIG. 5C is a plan view illustrating the relevant portion of the structure of the optical scanning device according to the first embodiment of the present invention;

FIG. 6A is a plan view illustrating a relevant portion of the structure of an optical scanning device according to a second embodiment of the present invention;

FIG. 6B is a right side view illustrating the relevant portion of the structure of the optical scanning device according to the second embodiment of the present invention;

FIG. 6C is a plan view illustrating the relevant portion of the structure of the optical scanning device according to the second embodiment of the present invention;

FIG. 7A is a plan view illustrating a relevant portion of the structure of an optical scanning device according to a third embodiment of the present invention;

FIG. 7B is a right side view illustrating the relevant portion of the structure of the optical scanning device according to the third embodiment of the present invention;

FIG. 7C is a plan view illustrating the relevant portion of the structure of the optical scanning device according to the third embodiment of the present invention;

FIG. 8A is a plan view illustrating a relevant portion of the structure of an optical scanning device according to a fourth embodiment of the present invention;

FIG. 8B is a right side view illustrating the relevant portion of the structure of the optical scanning device according to the fourth embodiment of the present invention; and

FIG. 8C is a plan view illustrating the relevant portion of the structure of the optical scanning device according to the fourth embodiment of the present invention.

### DETAILED DESCRIPTION OF THE INVENTION

Hereinafter, optical scanning devices according to embodiments of the present invention will be described in detail with reference to the drawings.

Description will be made of a first embodiment.

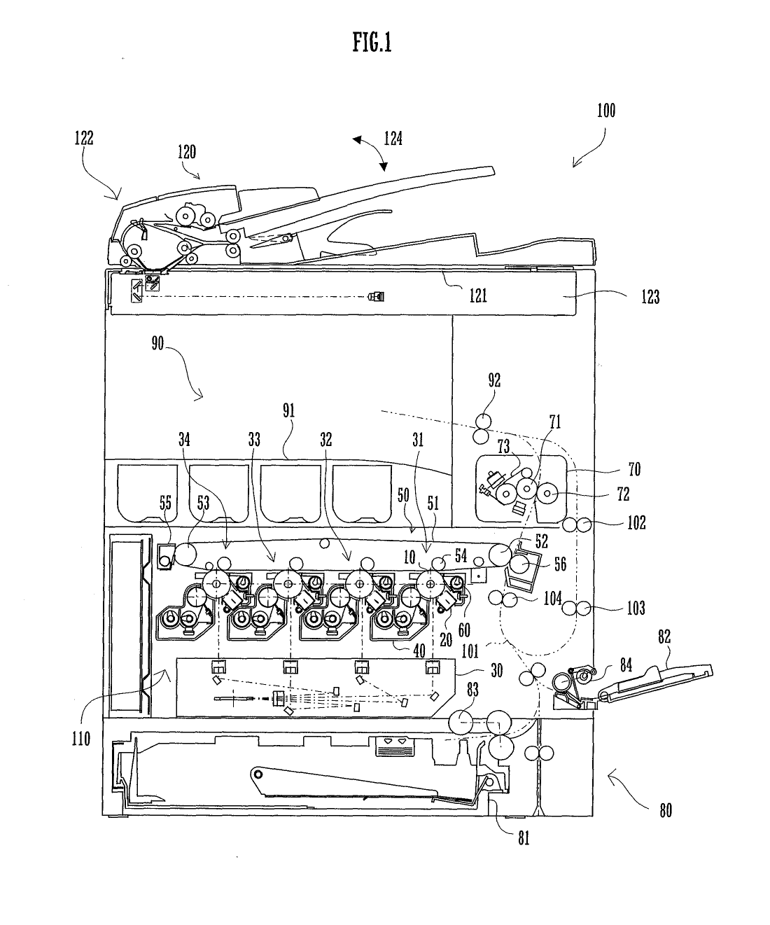

FIG. 1 is a view illustrating the structure of an image forming apparatus 100 incorporating an optical scanning device 30 according to the first embodiment of the present invention.

The image forming apparatus 100 is configured to form a polychrome or monochrome image on a predetermined sheet (i.e., recording sheet) in accordance with image data transmitted thereto from the outside. The image forming apparatus 100 includes a document processing device 120, a sheet feeding section 80, an image forming section 110, and an output section 90.

The document processing device 120 includes a document platen 121, a document feeder 122, and a document reading section 123. The document platen 121 is formed of transparent glass and is designed to allow a document to be placed thereon. The document feeder 122 feeds documents loaded on a document load tray one by one. The document feeder 122, which is capable of pivoting in a direction indicated by arrow 124, allows a document to be placed on the document platen 121 by exposing the top surface of the document platen 121 to the outside. The document reading section 123 reads a document being fed by the document feeder 122 or a document placed on the document platen 122.

The sheet feeding section 80 includes a sheet feed cassette 81, a manual feed cassette 82, and pickup rollers 83 and 84. The sheet feed cassette 81 is a tray for storing standard size sheets therein. The manual feed cassette 82 is a tray capable of receiving non-standard size sheets thereon. The pickup roller 83, which is located adjacent an end portion of the sheet feed cassette 81, picks up sheets one by one from the sheet feed cassette 81 to feed each sheet into a sheet feed path 101. Likewise, the pickup roller 84, which is located adjacent an end portion of the manual feed cassette 82, picks up sheets one by one from the manual feed cassette 82 to feed each sheet into the sheet feed path 101.

The image forming section 110 includes image forming stations 31 to 34, optical scanning device 30, intermediate transfer belt unit 50, and fixing unit 70. Each of the image forming stations 31 to 34 includes a photoreceptor drum 10, an electrostatic charger device 20, a developing device 40, and a cleaner unit 60. The image forming stations 31 to 34 are each adapted to form a color image by using a respective one of the colors, namely, black (K), cyan (C), magenta (M) and yellow (Y). In the present embodiment, description is directed to the image forming station 31.

The photoreceptor drum 10 rotates during image formation to bear a developer image thereon. Around the photoreceptor drum 10, there are disposed the electrostatic charger device 20, optical scanning device 30, developing device 40, intermediate transfer belt unit 50 and cleaner unit 60 in this order from an upstream side in the direction of rotation of the photoreceptor drum 10. The fixing unit 70 is disposed on the sheet feed path 101 at a location most downstream in the image forming section 110.

The electrostatic charger device 20 is means for electrostatically charging a peripheral surface of the photoreceptor drum 10 to a predetermined potential uniformly. Besides the charger type as shown in FIG. 1, a contact-type electrostatic charger device using a roller or a brush may be used.

The optical scanning device 30 has the function of exposing the photoreceptor drum 10 in an electrostatically charged state to light according to image data inputted thereto, thereby forming an electrostatic latent image on the peripheral surface of the photoreceptor drum 10 according to the image data. The optical scanning device 30 is constructed as a laser scanning unit (LSU) including a laser beam emitting section, a reflecting mirror and the like. In the optical scanning device 30, there are disposed a polygon mirror for scanning laser beams and optical components, such as a lens and a mirror, for guiding laser light reflected by the polygon mirror to the photoreceptor drum 10. These optical components will be described later. The optical scanning device 30 may employ a technique using a writing head having an array of light-emitting devices of other type such as ELs or LEDs for example.

The developing device 40 is configured to visualize the electrostatic latent image formed on the photoreceptor drum 10 by the use of toner.

The intermediate transfer belt unit 50 includes an intermediate transfer belt 51, an intermediate transfer belt driving roller 52, an intermediate transfer belt driven roller 53, an intermediate transfer roller 54, and an intermediate transfer belt cleaning unit 55.

The intermediate transfer belt driving roller 52, intermediate transfer belt driven roller 53 and intermediate transfer roller 54 entrain the intermediate transfer belt 51 thereabout to drive the intermediate transfer belt 51 for rotation. The intermediate transfer roller 54 performs application of a transfer bias for transferring a toner image from the photoreceptor drum 10 onto the intermediate transfer belt 51.

The intermediate transfer belt 51 is positioned so as to contact the photoreceptor drum 10. The intermediate transfer belt 51 has the function of forming a toner image thereon by transfer of the toner image from the photoreceptor drum 10 onto the intermediate transfer belt 51. The intermediate transfer belt 51 is formed into an endless belt by using a film having a thickness of about 100 μm to about 150 μm for example.

The transfer of the toner image from the photoreceptor drum 10 to the intermediate transfer belt 51 is achieved by the intermediate transfer roller 54 in contact with the reverse side of the intermediate transfer belt 51. The intermediate transfer roller 54 is applied with a high transfer bias voltage (i.e., a high voltage having a polarity (+) opposite to the polarity (−) of the toner charged) in order to transfer the toner image. The intermediate transfer roller 54 is a roller comprising a shaft of metal (e.g., stainless steel) having a diameter of 8 to 10 mm as a base, and an electrically conductive elastic material (e.g., EPDM or urethane foam) covering the surface of the shaft. The electrically conductive elastic material enables the intermediate transfer belt 51 to be uniformly applied with the high voltage. While the present embodiment uses the transfer electrode in the form of a roller, it is possible to use a transfer electrode in the form of a brush or the like instead of such a roller.

Electrostatic latent images thus visualized on the respective photoreceptor drums 10 are transferred onto the intermediate transfer belt 51 so as to be superimposed on one another. Image information obtained by the superimposition of the toner images is moved by rotation of the intermediate transfer belt 51 to a contact position between a sheet and the intermediate transfer belt 51 and is then transferred onto the sheet by the transfer roller 56 disposed at the contact position.

At that time, the intermediate transfer belt 51 and the transfer roller 56 are pressed against each other at a predetermined nip pressure, while the transfer roller 56 applied with the voltage for transferring the toner to the sheet (i.e., a high voltage having a polarity (+) opposite to the polarity (−) of the toner charged). For obtaining the nip pressure steadily, one of the transfer roller 56 and the intermediate transfer belt driving roller 52 comprises a hard material (e.g., metal or the like) and the other comprises a soft material such as an elastic roller (e.g., elastic rubber roller, expanded resin roller, or the like).

Toner thus attached to the intermediate transfer belt 51 by contact between the photoreceptor drum 10 and the intermediate transfer belt 51 or residual toner remaining on the intermediate transfer belt 51 without having been transferred onto the sheet by the transfer roller 56, is removed and recovered by the intermediate transfer belt cleaning unit 55. The intermediate transfer belt cleaning unit 55 includes, for example, a cleaning blade as a cleaning member for contact with the intermediate transfer belt 51. The intermediate transfer belt 51 contacted by the cleaning blade is supported by the intermediate transfer belt driven roller 53 from the reverse side thereof.

The cleaner unit 60 removes and recovers residual toner remaining on the peripheral surface of the photoreceptor drum 10 after the image transfer operation following the developing operation.

The fixing unit 70 includes a heating roller 71 and a pressurizing roller 72 which are configured to rotate while nipping a sheet therebetween. The heating roller 71 is controlled by a control section based on signals from a non-illustrated temperature detector so that a predetermined fixing temperature is reached. The heating roller 71 has the function of fusing, mixing and pressure-contacting the toner image transferred to the sheet by heat-bonding the toner to the sheet cooperatively with the pressurizing roller 71, thereby fixing the toner image onto the sheet by heat. An external heating belt 73 is provided for heating the heating roller 71 from the outside.

The output section 90 has a sheet catch tray 91 and sheet output rollers 92. The sheet having passed through the fixing unit 70 is outputted to the sheet catch tray 91 by passing between the sheet output rollers 92. The sheet catch tray 91 is a tray for accumulating thereon sheets finished with printing.

In cases where double-side printing is requested, when a sheet having been finished with single-side printing as described above and passed through the fixing unit 70 is held between the sheet output rollers 92 at its trailing edge, the sheet output rollers 92 rotate backwardly to feed the sheet to feed rollers 102 and then to feed rollers 103. Thereafter, the sheet is subjected to reverse side printing after having passed between registration rollers 104 and is then outputted to the sheet catch tray 91.

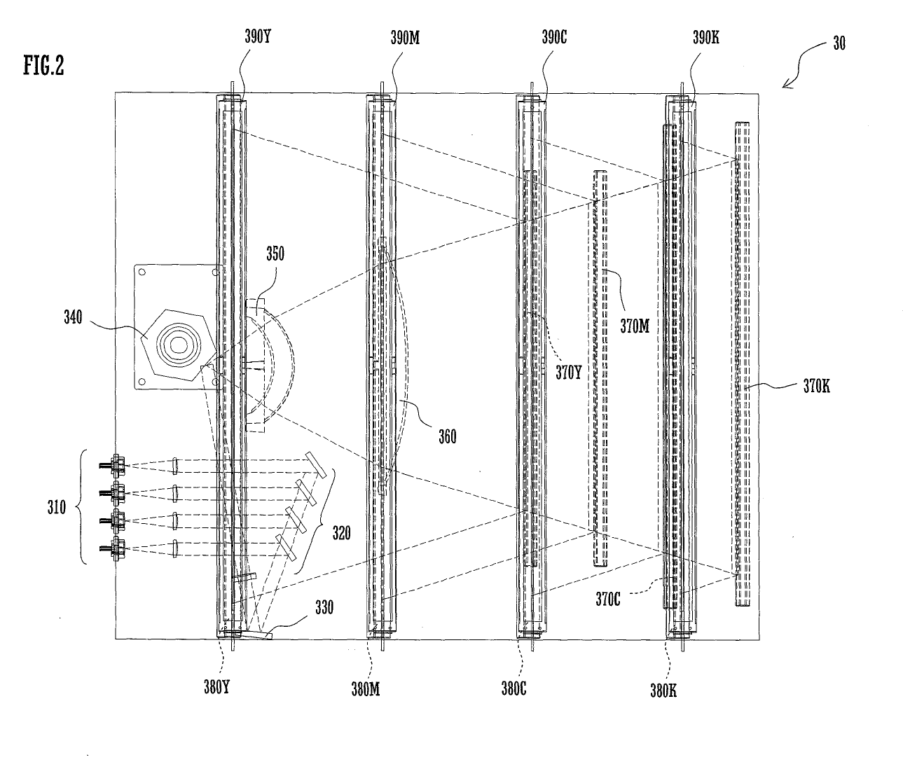

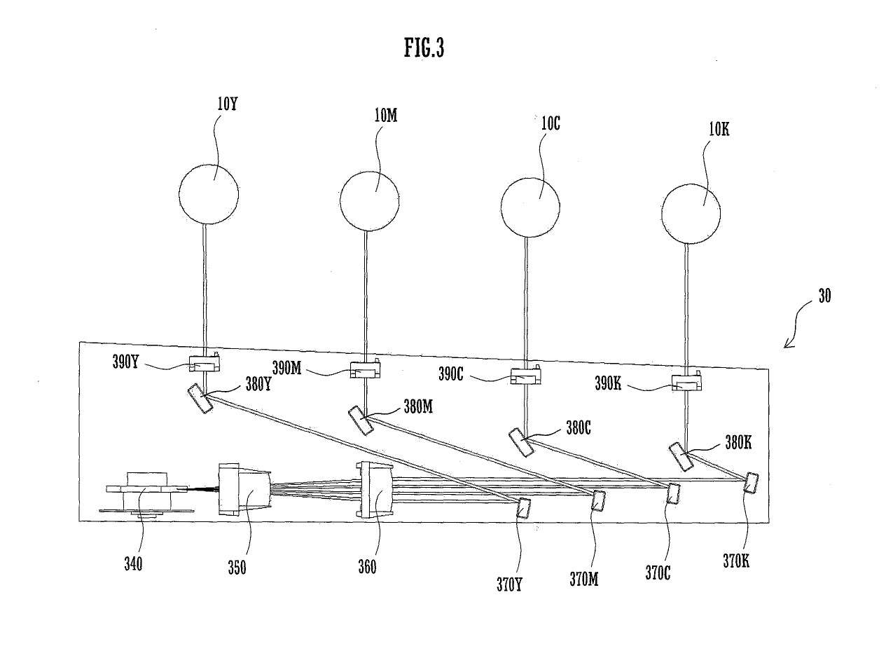

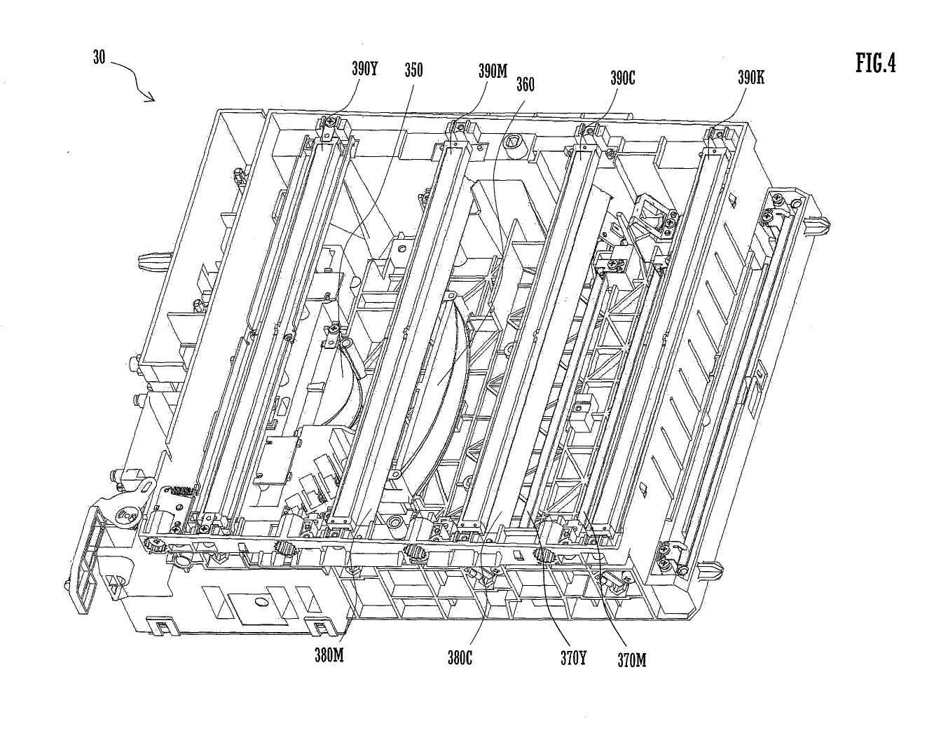

FIG. 2 is a plan view illustrating the structure of the optical scanning device 30 according to the first embodiment of the present invention. FIG. 3 is a side elevational view illustrating the structure of the optical scanning device 30 according to the first embodiment of the present invention. FIG. 4 is a perspective view illustrating the structure of the optical scanning device 30 according to the first embodiment of the present invention.

The optical scanning device 30 includes laser diodes 310, mirrors 320, a mirror 330, a polygon mirror 340, a first fθ lens 350, a second fθ lens 360, mirrors 370, mirrors 380, and third fθ lenses 390. Each of the third fθ lenses 390 is equivalent to the “optical element” defined by the present invention. Each of the laser diodes 310 is equivalent to the “light source” defined by the present invention.

In FIGS. 2 to 4, the reference characters “Y”, “M”, “C” and “K” added to the reference numerals “370” (mirrors 370), “380” (mirrors 380) and “390” (fθ lenses 390) correspond to photoreceptor drums 10Y (yellow), 10M (magenta), 10C (cyan) and 10K (black), respectively.

The laser diodes 310 each emit a laser beam associated with a respective one of the colors, i.e., yellow, magenta, cyan and black. The mirrors 320 reflect the laser beams emitted from the respective laser diodes 310 toward the mirror 330. The mirror 330 reflects the laser beams reflected from the mirrors 320 toward the polygon mirror 340.

The polygon mirror 340, which is in the form of an equilateral polygonal column, is driven to rotate at a high velocity during image formation. The polygon mirror 340 performs equiangular scanning in the primary scanning direction by reflecting the laser beams reflected from the mirror 330 by mirrors forming the respective lateral sides of the polygon mirror 340. The first fθ lens 350 and the second fθ lens 360 have the function of changing the primary scanning velocity of the laser beams having been equiangularly scanned by the polygon mirror 340 to a constant scanning velocity for scanning over the photoreceptor drums 10. The first fθ lens 350 and the second fθ lens 360 further have the function of reducing the diameter of each laser beam in the primary scanning direction.

The mirrors 370 reflect the laser beams having passed through the first fθ lens 350 and the second fθ lens 360 toward the mirrors 380. The mirrors 380 reflect the laser beams reflected by the mirrors 370 toward the third fθ lenses 390. The third fθ lenses 390 have the function of adjusting the laser beams reflected from the mirrors 380 so that each laser beam is applied onto a predetermined point on the associated photoreceptor drum 10. The third fθ lenses 390 further have the function of reducing the diameter of each laser beam in the secondary scanning direction.

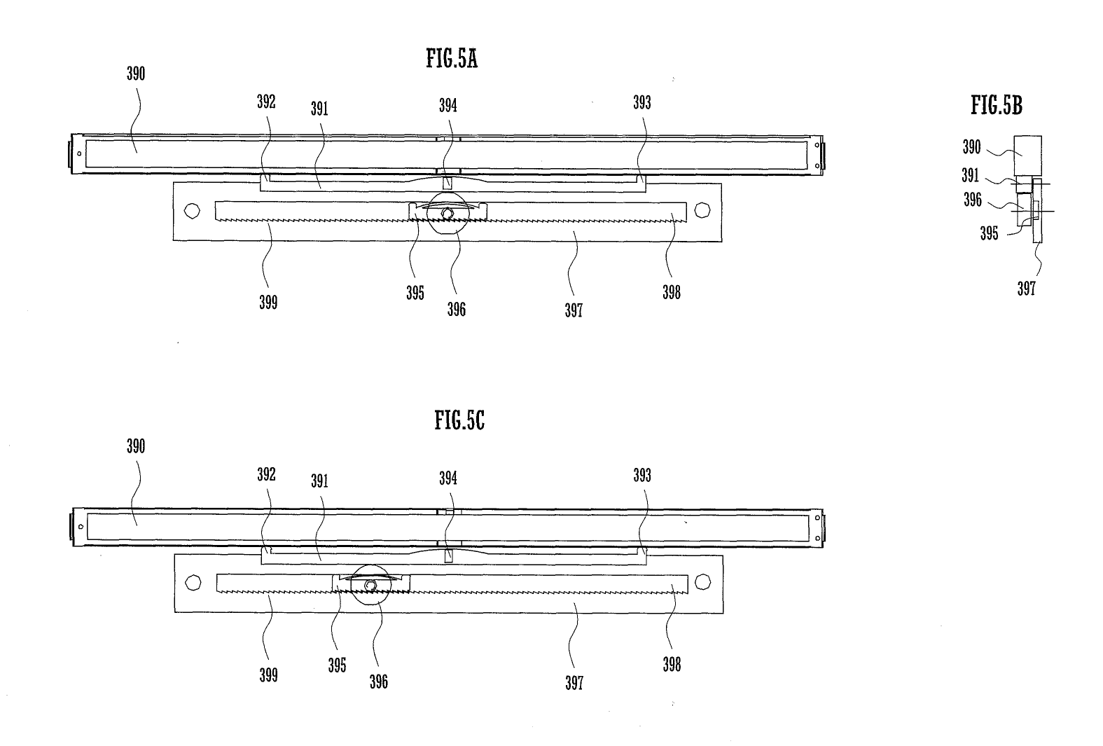

FIG. 5 illustrates a relevant portion of the structure of the optical scanning device 30 according to the first embodiment of the present invention.

Specifically, FIG. 5A is a plan view illustrating the relevant portion of the structure of the optical scanning device 30, and FIG. 5B is a right side view illustrating the relevant portion of the structure of the optical scanning device 30. The optical scanning device 30 includes third fθ lens 390, adjusting bar 391, pressing portion 395, columnar member 396, and movement restraining section 397. The adjusting bar 391 is equivalent to the “first adjusting section” defined by the present invention. The pressing portion 395 and the columnar member 396 form an equivalent of the “first pressing section” defined by the present invention. The movement restraining section 397 is equivalent to the “first movement restraining section” defined by the present invention.

The third fθ lens 390 is disposed in an optical path extending from laser diode 310 to photoreceptor drum 10 and is configured to correct a scanning line emitted from the laser diode 310. The adjusting bar 391 is disposed parallel with the longitudinal direction of the third fθ lens 390 and has projections 392 and 393 which are capable of pressing against the third fθ lens 390 at two points in the longitudinal direction of the third fθ lens 390. The pressing portion 395 and the columnar member 396 are configured to press the adjusting bar 391 against the third fθ lens 390. The movement restraining section 397 is configured to set the pressing portion 395 and the columnar member 396 in a first state in which the pressing portion 395 and the columnar member 396 are movable in a direction parallel with the longitudinal direction of the third fθ lens or in a second state in which the pressing portion 395 and the columnar member 396 are restrained from moving.

The adjusting bar 391 has an elongated hole serving as an axis along which the adjusting bar 391 is movable in a direction perpendicular to that surface of the third fθ lens 390 which faces the projections 392 and 393. The adjusting bar 391 is capable of easily adjusting the pressing forces of the projections 392 and 393 exerted on the third fθ lens 390 by movement of the pressing portion 395 and columnar member 396 to be described later. Further, the adjusting bar 391 provided with the two projections 392 and 393 can deform the third fθ lens 390 so as to reduce the curvature of a scanning line.

While the present embodiment employs the arrangement provided with the two projections on the adjusting bar 391, there is no limitation to such an arrangement. Any number of projections may be provided as long as the number of projections is two or more because substantially the same effect of reducing the curvature of a scanning line will result.

The pressing portion 395 is fitted in a slot 398 of the movement restraining section 397. The pressing portion 395 has moving means such as a roller and hence is movable along the slot 398 by the moving means. The pressing portion 395 is formed with a threaded hole for mounting the columnar member 395. The columnar member 396 is formed with a screw portion on the side to be fitted on the pressing portion 395 and, hence, the screw portion is threadingly engageable with the threaded hole of the pressing portion 395.

The columnar member 396 is formed with a cross recess centrally of a top surface thereof. By rotating a cross slot screwdriver fitted in the cross recess, the columnar member 396 can be fastened to the pressing portion 395. The screw portion of the columnar member 396 and the center of the cross recess are not offset from each other. The columnar member 396 has the function of transmitting the pressing force of the pressing portion 395 to the adjusting bar 391.

The movement restraining section 397 has a surface 399 formed into a rack gear. The surface 399 of the slot 398 extends parallel with the longitudinal direction of the third fθ lens 390. The pressing portion 395 has a surface facing the surface 399 which is formed into a gear for meshing with the surface 399. The pressing portion 395 has an arcuate member in contact with that surface of the slot 398 which is opposite to the surface 399, the arcuate member exhibiting a spring action to cause the pressing portion 395 to mesh with the surface 399.

Since the pressing portion 395 meshes with the surface 399 during a normal state, the position of the pressing portion 395 is fixed. This fixed state is equivalent to the “second state” defined by the present invention. In moving the pressing portion 395, the pressing portion 395 is pressed against the surface facing the arcuate member so as to be disengaged from the surface 399 and is then moved along the slot 398 while being kept pressed against the surface facing the arcuate member. This pressed state is equivalent to the “first state” defined by the present invention. When the pressing portion 395 is released from the pressed state, the pressing portion 395 meshes the surface 399 again and becomes fixed at that position.

There is no limitation to the above-described method of moving the pressing portion 395. For example, the pressing position of the pressing portion 395 may be controlled by driving means such as a stepping motor.

FIG. 5C is a view illustrating a state in which the pressing portion 395 and the columnar member 396 have been moved from the state shown in FIG. 5A. In FIG. 5C, the pressing portion 395 and the columnar member 396 have been moved closer to the projection 392 than the central portion of the adjusting bar 391. In this state, the pressing force of the pressing portion 395 and columnar member 396 is transmitted to the projection 392 more intensively than the projection 393. Therefore, the amount of deformation of the third fθ lens 390 on the projection 392 side is larger than on the projection 393 side.

On the other hand, in a state in which the pressing portion 395 and the columnar member 396 have been moved closer to the projection 393 than the central portion of the adjusting bar 391, the pressing force of the pressing portion 395 and columnar member 396 is transmitted to the projection 393 more intensively than the projection 392. Therefore, the amount of deformation of the third fθ lens 390 on the projection 393 side is larger than on the projection 392 side.

Since the arrangement according to the present embodiment is capable of deforming the third fθ lens 390 by using the single combination of the pressing portion 395 and the columnar member 396 to press against the adjusting bar 391 which can press against the third fθ lens 390 at two points, the amount of deformation of the third fθ lens 390 can be adjusted easily. Specifically, by moving the pressing portion 395 and the columnar member 396 in a direction parallel with the longitudinal direction of the third fθ lens 390, the point of effort of the pressing portion 395 and columnar member 396 on the adjusting bar 396 can be shifted and, hence, the pressing forces exerted by the respective projections 392 and 393 against the third fθ lens 390 can be adjusted easily.

Further, since the arrangement according to the present embodiment is capable of pressing against the third fθ lens 390 at two points, the third fθ lens 390 can be deflected at two portions thereof. Therefore, this arrangement is an arrangement which can reduce the curvature of a scanning line effectively and which can adjust the amount of deformation of the third fθ lens 390 easily.

Description will be made of a second embodiment of the present invention.

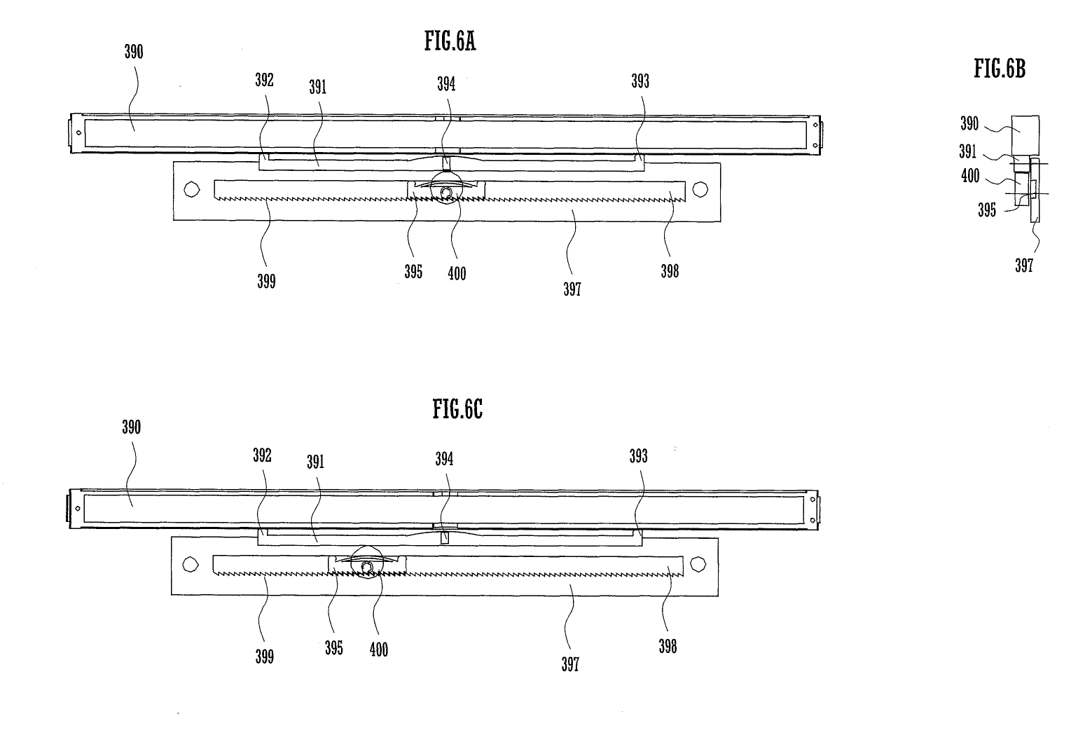

FIG. 6 illustrates a relevant portion of the structure of the optical scanning device 30 according to the second embodiment of the present invention. Throughout the second to fourth embodiments, redundant description will not be made of the features having been already described in relation to the first embodiment.

FIG. 6A is a plan view illustrating the relevant portion of the structure of the optical scanning device 30, and FIG. 6B is a right side view illustrating the relevant portion of the structure of the optical scanning device 30. In the present embodiment, the pressing portion 395 has a cam portion 400 instead of the columnar member 396. The pressing portion 395 is formed with a threaded hole for mounting the cam portion 400.

The cam portion 400 is formed with a screw portion on the side to be fitted on the pressing portion 395 and, hence, the screw portion is threadingly engageable with the threaded hole of the pressing portion 395. The cam portion 400 is formed with a cross recess centrally of a top surface thereof. The screw portion of the cam portion 400 and the center of the cross recess are offset from each other. For this reason, the pressing force of the pressing portion 395 against the adjusting bar 391 can be adjusted by rotating a cross slot screwdriver fitted in the cross recess.

Thus, the arrangement according to the present embodiment is capable of fine adjustment of the pressing forces transmitted from the pressing portion 395 and cam portion 400 to the projections 392 and 393. For example, when it is desired that the projection 392 side of the third fθ lens 390 should be deformed more largely than the projection 393 side, fine adjustment can be made of the amount of deformation of the third fθ lens 390 by moving the pressing portion 395 and the cam portion 400 into the position shown in FIG. 6C and then rotating the cam portion 400. In this way, the third fθ lens 390 can be deformed by an amount desired by the user and, hence, the curvature of a scanning line can be reduced effectively.

Description will be made of a third embodiment of the present invention.

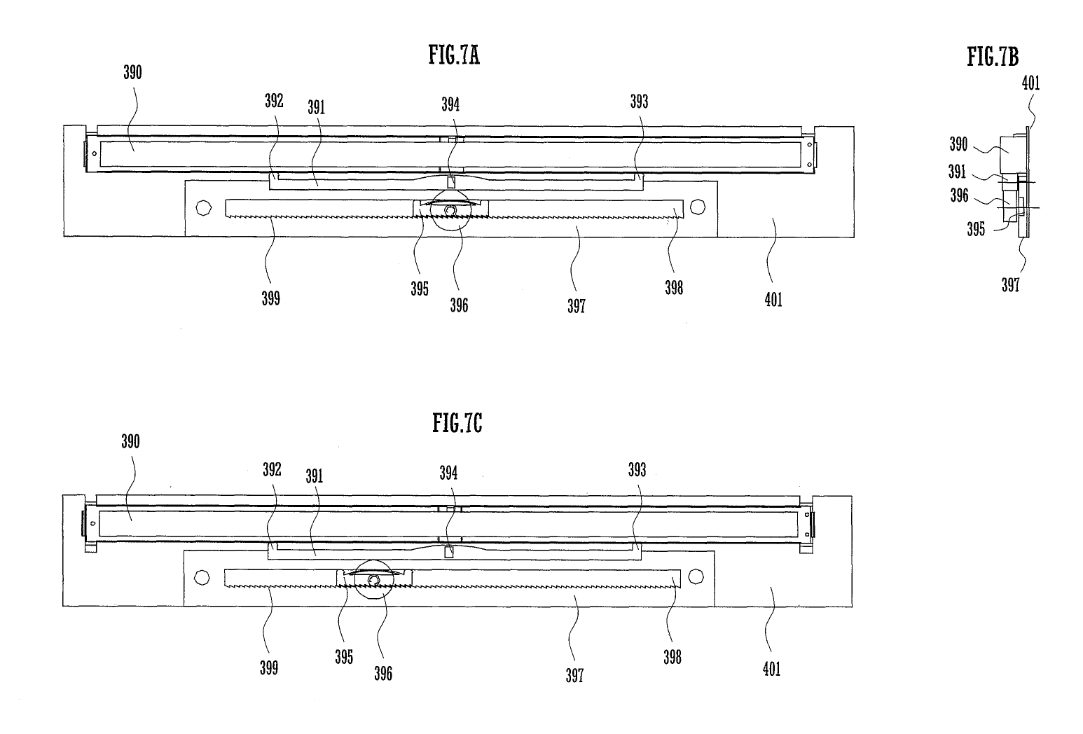

FIG. 7 illustrates a relevant portion of the structure of the optical scanning device 30 according to the third embodiment of the present invention.

Specifically, FIG. 7A is a plan view illustrating the relevant portion of the structure of the optical scanning device 30, and FIG. 7B is a right side view illustrating the relevant portion of the structure of the optical scanning device 30. In the present embodiment, the optical scanning device 30 is provided with a holder 401 which is removable from the optical scanning device 30 and which holds the third fθ lens 390, adjusting bar 391, pressing portion 395, columnar member 396 and movement restraining section 397 as a unity.

In the arrangement according to the present embodiment, the members for deforming the third fθ lens 390 are held by the single holder 401 and, hence, the holder 401 and the members for deforming the third fθ lens 390 can be handled as one unit. Therefore, with the unit being removed from the optical scanning device 30, the amount of deformation of the third fθ lens 390 can be adjusted as shown in FIG. 7C for example. Thus, it is possible to reduce the curvature of a scanning line easily.

Description will be made of a fourth embodiment of the present invention.

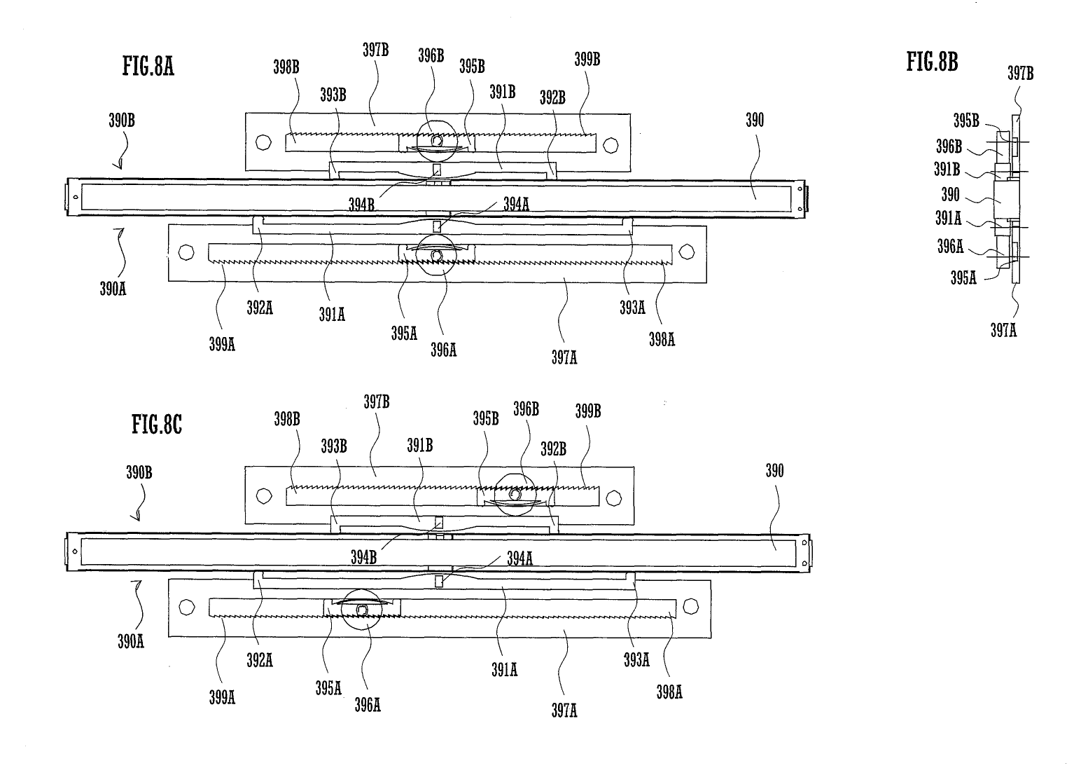

FIG. 8 illustrates a relevant portion of the structure of the optical scanning device 30 according to the fourth embodiment of the present invention.

Specifically, FIG. 8A is a plan view illustrating the relevant portion of the structure of the optical scanning device 30, and FIG. 8B is a right side view illustrating the relevant portion of the structure of the optical scanning device 30. The present embodiment further includes an adjusting bar 391B, a pressing portion 395B, a columnar member 396B and a movement restraining section 397B, in addition to the structure of the first embodiment. The adjusting bar 391B is equivalent to the “second adjusting section” defined by the present invention. The pressing portion 395B and the columnar member 396B form an equivalent of the “second pressing section” defined by the present invention. The movement restraining section 397B is equivalent to the “second movement restraining section” defined by the present invention.

The adjusting bar 391B is disposed parallel with the longitudinal direction of the third fθ lens 390 and has projections 392B and 393B which are capable of pressing against the third fθ lens 390 at plural points in the longitudinal direction of the third fθ lens 390. The pressing portion 395B and the columnar member 396B press the adjusting bar 391B against the third fθ lens 390. The movement restraining section 397B is configured to set the pressing portion 395B and the columnar member 396B in a third state in which the pressing portion 395B and the columnar member 396B are movable in a direction parallel with the longitudinal direction of the third fθ lens 390 or in a fourth state in which the pressing portion 395B and the columnar member 396B are restrained from moving.

An adjusting bar 391A, pressing portion 395A, columnar member 396A and movement restraining section 397A are disposed at a side surface 390A of the third fθ lens 390 which extends parallel with the longitudinal direction of the third fθ lens 390. On the other hand, the adjusting bar 391B, pressing portion 395B, columnar member 396B and movement restraining section 397B are disposed at a side surface 390B of the third fθ lens 390 which extends parallel with the longitudinal direction of the third fθ lens 390. The side surface 390A is equivalent to the “first side surface” defined by the present invention. The side surface 390B is equivalent to the “second side surface” defined by the present invention. The spacing between endmost projections 392B and 393B provided at opposite extremities of the adjusting bar 391B is narrower than that between endmost projections 392A and 393A provided at opposite extremities of the adjusting bar 391A.

Since the pressing portion 395B meshes with a surface 399B during a normal state, the position of the pressing portion 395B is fixed. This fixed state is equivalent to the “fourth state” defined by the present invention. In moving the pressing portion 395B, the pressing portion 395 is pressed against the surface facing the arcuate member so as to be disengaged from the surface 399B and is then moved along a slot 398B while being kept pressed against the surface facing the arcuate member. This pressed state is equivalent to the “third state” defined by the present invention. When the pressing portion 395B is released from the pressed state, the pressing portion 395B meshes the surface 399B again and becomes fixed at that position.

The arrangement according to the present embodiment wherein the spacing between the points of contact of the projections 392A and 393A with the third fθ lens 390 and is different from that between the points of contact of the projections 392B and 393B with the third fθ lens 390, is capable of pressing against the third fθ lens 390 from the opposite sides thereof. Further, since this arrangement allows the pressing portions 395A and 395B and the columnar members 396A and 396B to be moved into their respective desired positions, finer adjustment of the amount of deformation of the third fθ lens 390 is possible than the arrangement for pressing against the third fθ lens 390 from one side thereof. Therefore, the arrangement according to the present embodiment can effectively reduce the curvature of a scanning line.

The first to fourth embodiments of the present invention may be combined as desired. Therefore, the combination of features or components of the embodiments can be changed to meet practical uses.

The foregoing embodiments are illustrative in all points and should not be construed to limit the present invention. The scope of the present invention is defined not by the foregoing embodiments but by the following claims. Further, the scope of the present invention is intended to include all modifications within the scopes of the claims and within the meanings and scopes of equivalents.

What is claimed is:

1. An optical scanning device comprising:
an optical element disposed in an optical path extending from a light source to a photoreceptor and configured to correct a scanning line emitted from the light source;
a first adjusting section disposed parallel with a longitudinal direction of the optical element and having projections which are capable of pressing against the optical element at plural points in the longitudinal direction of the optical element;
a first pressing section configured to press the first adjusting section against the optical element; and
a first movement restraining section configured to set the first pressing section in a first state in which the first pressing section is movable in a direction parallel with the longitudinal direction of the optical element or in a second state in which the first pressing section is restrained from moving.

2. The optical scanning device according to claim 1, wherein the first pressing section has a cam portion which is capable of adjusting a pressing force of the first pressing section against the first adjusting section by rotation thereof.

3. The optical scanning device according to claim 1, further comprising a holder which is removable from an optical scanning device body and which holds the optical element, the first adjusting section, the first pressing section and the first movement restraining section as a unity.

4. The optical scanning device according to claim 1, further comprising:
a second adjusting section disposed parallel with the longitudinal direction of the optical element and having projections which are capable of pressing against the optical element at plural points in the longitudinal direction of the optical element;
a second pressing section configured to press the second adjusting section against the optical element; and
a second movement restraining section configured to set the second pressing section in a third state in which the second pressing section is movable in the direction parallel with the longitudinal direction of the optical element or in a fourth state in which the second pressing section is restrained from moving, wherein:
the first adjusting section, the first pressing section and the first movement restraining section are disposed at a first side surface of the optical element which extends parallel with the longitudinal direction of the optical element;
the second adjusting section, the second pressing section and the second movement restraining section are disposed at a second side surface of the optical element which is opposite away from the first side surface; and
a spacing defined between endmost ones of the projections at opposite extremities of the second adjusting section is narrower than a spacing defined between endmost ones of the projections at opposite extremities of the first adjusting section.

5. An image forming apparatus comprising:
a photoreceptor; and
the optical scanning device according to claim 1 for applying a scanning line modulated according to image information onto the photoreceptor.
